(19) United States
(12) Patent Application Publication
(10) Pub. No.: US 2026/0222101 A1
(43) Pub. Date: Jul. 30, 2026

(54) OPTICAL SWITCHING APPARATUS, OPTICAL ADD/DROP MULTIPLEXER AND COMMUNICATIONS NETWORK NODE

(71) Applicant: Telefonaktiebolaget LM Ericsson (publ), Stockholm (SE)

(72) Inventors: Paola IOVANNA, Pisa (IT); Alessandra BIGONGIARI, Pisa (IT)

(21) Appl. No.: 19/141,501

(22) PCT Filed: Dec. 21, 2022
(86) PCT No.: PCT/EP2022/087349

§ 371 Date: Jun. 20, 2025

(51) Int. Cl. H04J 14/02

(52) U.S. Cl. CPC H04J 14/0212; H04J 14/0213

(57) ABSTRACT

Optical switching apparatus (100) for dropping optical channel signals, comprising: an input (102) to receive optical channel signals; drop ports (104); working optical waveguides (106); bypass optical waveguides (108); optical bypass switches (110) each having at least one input configured to receive optical channel signals, a first output connected to a respective working optical waveguide and a second output connected to a respective bypass optical waveguide, wherein the optical bypass switches are reconfigurable between a working configuration in which received optical channel signals are routed to the respective first output and a bypass configuration in which received optical channel signals are routed to the respective second output; wavelength selective optical switching elements (112) coupled to respective working optical waveguides, operable to drop optical channel signals at different channel wavelengths from respective working optical waveguides to respective drop ports; and an output (116) configured to output optical channel signals that have not been dropped to a drop port.

### TECHNICAL FIELD

The invention relates to optical switching apparatus for dropping optical channel signals. The invention further relates to an optical add-drop multiplexer. The invention further relates to a communications network node.

### BACKGROUND

Nowadays in the radio access network, RAN, to reduce capex cost, Fronthaul and Backhaul applications make use of fixed optical filters. This allows to use dense wavelength division multiplexing, DWDM, transmission to reduce fibre cost, since DWDM allows the use of a single fibre for multiple optical channels, but impacts on operational cost. Such fixed optical fibre prevent any dynamic configuration, and require high cost of inventory since for each optical channel a corresponding fixed filter must be used. This impacts inventory because it is necessary to store many transceivers, TRXs, covering all channel wavelength variants. Moreover, operations in field (e.g., configuration or fault recovery) cannot be performed as simple plug and play of modules and patch cords, because it is necessary to connect the correct filter port to the right TRX. Fixed filters and transceivers require a rigid wavelength planning from day one and do not allow to change it without complex hardware changes in the field.

Reconfigurable optical add drop multiplexers, ROADM, can be realized using tunable filters to operate the wavelength selection and realize a fully reconfigurable network deployment. The available commercial technologies for the realization of tunable filters are based on Microelectromechanical Mirrors, MEMS, Liquid Crystal on glass, and Liquid Crystal on Silicon, LCOS. LCOS technology dominates current wavelength selective switches, WSS, because it can support flexible channel plans. However, LCOS devices are polarization dependent, and require a polarization diversity configuration. These technologies also face challenges of cost, size, port isolation, and crosstalk. An alternative could be the use of high performance WSS that are used in current optical metro haul networks. These WSS can be used to have dynamic reconfiguration and reduce inventory cost, but cannot match the cost and consumption target for applications in the access network. Hence alternative, less expensive and power efficient technologies are required to address the transport solution on the access network.

At present, there are research and innovation activity that proposed the study and realization of tunable filters integrated in silicon photonics. Such technology allows to realize alternative solutions that allow to reduce cost and consumption. Such filters are used to add and drop a selection of channels in an add/drop node. For example, U.S. Pat. No. 9,806,841B2 describes an architecture for a reconfigurable add and drop node, referred as ‘mini-ROADM’, that is realized in silicon photonics.

V. Sorianello et al, “Experimental evaluation of residual added signal crosstalk in a silicon photonics integrated ROADM,” in Proc. OFC, 2014, Paper Th2A.30 describes an integrated ROADM that uses the same bus optical waveguide both for add and drop direction. Reflections in the optical bus cause a high level of crosstalk between the add channels and the drop filters, which is made worse by the fact that the power level of drop channels is much lower than the add channels.

For this reason, the architecture in FIG. 11 of P. Iovanna et al., “Optical Components for Transport Network Enabling The Path to 6G, Journal of Lightwave Technology, Vol. 40, Issue 2, 15 Jan. 2022, has separate add and drop buses. It also includes a polarization diversity scheme to account for the variability of the polarization that is input by the external fibres. In this solution each port drops a given channel that is configured at the beginning. The tunability of the drop filter is limited to the initial configuration; then the filter can either be tuned to drop the specific channel that has been configured or be detuned so to not drop that specific channel. The detuning is operated by tuning the filter on a wavelength value that is in the ‘empty space’ between the configured channel and the adjacent channel.

### SUMMARY

It is an object to provide an improved optical switching apparatus for dropping optical channel signals. It is a further object to provide an improved optical add-drop multiplexer. It is a further object to provide an improved communications network node.

An aspect provides optical switching apparatus for dropping optical channel signals. The apparatus comprises an input configured to receive optical channel signals, a plurality of drop ports, a plurality of working optical waveguides, a plurality of bypass optical waveguides, a plurality of optical bypass switches, a plurality of wavelength selective optical switching elements and an output. The optical bypass switches each have at least one input, a first output and a second output. The input is configured to receive optical channel signals. The first output is connected to a respective working optical waveguide and the second output connected to a respective bypass optical waveguide. The optical bypass switches are reconfigurable between a working configuration in which received optical channel signals are routed to the respective first output and a bypass configuration in which received optical channel signals are routed to the respective second output. The wavelength selective optical switching elements are coupled to respective working optical waveguides. The wavelength selective optical switching elements are operable to drop optical channel signals at different channel wavelengths from respective working optical waveguides to respective drop ports. The output is configured to output optical channel signals that have not been dropped to a drop port.

The optical switching apparatus enables individual wavelength selective optical switching elements to be selectively bypassed. This may enable optical channel signals to continue to pass through or be dropped by other ports while changes are made to bypassed wavelength selective optical switching elements, without creating any disturbance to the optical channel signals.

In an embodiment, the optical bypass switches are operative to be configured in the bypass configuration in response to a respective bypass control signal. The wavelength selective optical switching elements are tunable wavelength selective optical switching elements. The wavelength selective optical switching elements are operative to change the channel wavelength at which optical channel signals are dropped in response to a respective wavelength control signal received when the respective optical bypass switch is configured in the bypass configuration by a respective bypass control signal.

This may enable “hot retuning” of a wavelength selective optical switching element, i.e. re-tuning the drop wavelength of a selected wavelength selective optical switching element without disrupting other optical channel signals due to crosstalk. This may simplify planning and operation of a network because it relaxes the need to have a rigid initial configuration of the wavelength allocation. This may enable full reconfiguration of the drop ports since the bypass mitigates problems of crosstalk and interference that can otherwise be generated during the tuning procedure of a wavelength selective optical switching element. These problems have previously presented a substantial limitation on the reconfigurability of drop ports, which would otherwise require a complex scheduling of the optical channel signals to be dropped at the specific optical switching apparatus, and at all optical switching apparatus for dropping optical channel signals within a communications network add-drop node chain. The optical switching apparatus may thus enable a reduced cost of inventory, simplified operation in field both during configuration and fault recovery, dynamic network planning, full reconfiguration of drop ports and on the fly wavelength reconfiguration.

In an embodiment, the bypass optical switches are Mach-Zehnder interferometers, MZI, or microelectromechanical mirrors, MEMS. The MZI have two inputs. These advantageously operate at low power, are non-wavelength selective and have a wide operating bandwidth.

In an embodiment, the wavelength selective optical switching elements are optical resonator based filters.

In an embodiment, the optical resonator based filters are micro-ring resonator, MRR, channel dropping filters.

In an embodiment, an MRR channel dropping filter comprises a single MRR.

In an embodiment, an MRR channel dropping filter comprises a plurality of MRRs configured as one of a cascade of MRRs or coupled MRRs.

In an embodiment, the optical switching apparatus further comprises a polarization splitter at the input, an output polarization combiner provided at the output and respective drop polarization combiners provided at drop ports. The polarization splitter is configured to split received optical channel signals into respective first polarization components and second polarization components. The output polarization combiner is configured to recombine first polarization components and second polarization components of optical channel signals that have not been dropped to a drop port. The drop polarization combiners are configured to recombine respective first polarization components and second polarization components of optical channel signals for delivery to respective drop ports. Drop ports have respective first optical bypass switches, first working optical waveguides, first bypass optical waveguides, and first wavelength selective optical switching elements for the optical channel signal first polarization components. Drop ports additionally have respective second optical bypass switches, second working optical waveguides, second bypass optical waveguides, and second wavelength selective optical switching elements for the optical channel signal second polarization components. The first and second wavelength selective optical switching elements of respective drop ports are operable to drop first polarization components and second polarization components at a same channel wavelength from the respective first working optical waveguide and second working optical waveguide to the drop polarization combiner at the drop port.

Converting optical channel signals to be dropped into two separate polarization components may overcome polarization dependency of wavelength selective optical switching elements. Recombining the two polarization components in the drop polarization combiner converters enables substantially the entire optical channel signal (bar any component losses) to be dropped from an optical network. The optical switching apparatus may thereby enable optical channels dropping from an optical network with low polarization sensitivity.

In an embodiment, the polarization splitter is a polarization splitter converter configured to split received optical channel signals into first TE polarization components and TM polarization components, and to convert the TM polarization components into second TE polarization components. The output polarization combiner is an output polarization combiner converter configured to receive first TE polarization components and second TE polarization components, and configured to recombine first TE polarization components and second TE polarization components of respective optical channel signals that have not been dropped to a drop port. The drop polarization combiners are drop polarization combiner converters configured to receive first TE polarization components and second TE polarization components, and configured to recombine first TE polarization components and second TE polarization components of optical channel signals for delivery to respective drop ports.

Converting optical channel signals to be dropped into two separate polarization components both having TE polarization advantageously overcomes polarization dependency of wavelength selective optical switching elements, enabling the wavelength selective switching elements to operate correctly, and in an effectively polarization agnostic manner. Recombining the two TE polarization components in the drop polarization combiner converters enables substantially the entire optical channel signal (bar any component losses) to be dropped from an optical network. The optical switching apparatus may thereby enable optical channels dropping from an optical network with low polarization sensitivity, avoiding a duplication of optical components with benefit in terms of cost, size and power consumption, that are crucial for application in centralized radio access network, C-RAN, wireless networks. In an embodiment, optical switching apparatus further comprises a bus optical waveguide, a polarization splitter converter, a plurality of first and second optical drop paths, and a plurality of polarization combiner converters. The bus optical waveguide has a first end and a second end. The working optical paths and the bypass optical switches comprise part of the bus optical waveguide. The polarization splitter converter is configured to split received optical channel signals into first TE polarization components and TM polarization components, and to convert the TM polarization components into second TE polarization components. The polarization splitter converter is further configured to couple first TE polarization components into the bus optical waveguide to travel in one direction and to couple second TE polarization components into the bus optical waveguide to travel in an opposite direction. The wavelength selective optical switching elements are operable to drop optical channel signals at different channel wavelengths from respective working optical waveguides to respective first and second optical drop paths. The polarization combiner converters are provided between respective drop ports and first and second optical drop paths coupled to respective wavelength selective optical switching elements. The polarization combiner converters are configured to receive first TE polarization components and second TE polarization components from respective first and second optical drop paths, and are configured to combine first TE polarization components and second TE polarization components of respective optical channel wavelengths to form optical channel signals for delivery to the respective drop port.

Converting optical channel signals to be dropped into two separate polarization components both having TE polarization advantageously overcomes polarization dependency of wavelength selective optical switching elements, enabling the wavelength selective switching elements to operate correctly, and in an effectively polarization agnostic manner. Recombining the two TE polarization components in the polarization combiner converters enables substantially the entire optical channel signal (bar any component losses) to be dropped from an optical network. Coupling first TE polarization components into the bus optical waveguide to travel in one direction and to couple second TE polarization components into the bus optical waveguide to travel in an opposite direction may minimize interference between the first and second TE polarization components of an optical channel signal within the bus optical waveguide. The optical switching apparatus may thereby enable optical channels dropping from an optical network with low polarization sensitivity.

In an embodiment, the polarization splitter converter comprises a dual-polarization grating coupler or a polarization splitter rotator.

In an embodiment, the polarization combiner converters comprise dual-polarization grating couplers or polarization splitter rotators.

In an embodiment, the bus optical waveguide is a folded optical waveguide.

In an embodiment, the optical channel signals carry information bits having a bit time. The respective optical path difference of the bus optical waveguide to each wavelength selective optical switching element from the first end of the bus optical waveguide and from the second end of the bus optical waveguide results in a delay between the respective first TE polarization component and second TE polarization component of a fraction of the bit time.

This advantageously means that the effect of the optical path difference experienced by the first and second TE polarization components on the eye diagram and bit error rate, BER, of the recombined optical channel signals output from the polarization combiner converters is negligible.

In an embodiment, the delay is up to 10% of the bit time. This advantageously means that the effect of the optical path difference experienced by the first and second TE polarization components on the eye diagram and bit error rate, BER, of the recombined optical channel signals output from the polarization combiner converters is negligible.

In an embodiment, the optical switching apparatus further comprises delay elements in drop paths of drop ports. The delay elements are configured to add different compensating delays to one of the first TE polarization component and second TE polarization component of channels being dropped. This may enable an increase in the bit rate that the channels can carry and/or an increase in the length of the optical bus waveguide and the number of wavelength selective switches that may be incorporated, and thus the number of different channels that can be handled.

In an embodiment, the optical switching apparatus further comprises a polarization controller at the input. This addresses polarization variability of received optical channel signals, enabling the polarization of each to be controlled to pre-selected polarisation and thus removing the need for a polarization diversity scheme.

In an embodiment, the optical switching apparatus further comprises respective optical amplifiers between wavelength selective optical switching elements and respective drop ports. The amplifiers enable correction of impairments in optical channel signals to be dropped before they reach the respective receiver. It is possible to control the output power towards each receiving transceiver in an independent manner so to compensate possible impairments of the channels.

In an embodiment, the optical switching apparatus is fabricated as a silicon photonic integrated circuit.

Corresponding embodiments and advantages also apply to the optical add-drop multiplexer described below.

An aspect provides an optical add-drop multiplexer comprising first optical coupling apparatus, second optical coupling apparatus, optical switching apparatus for dropping optical channel signals and an optical combiner. The first optical coupling apparatus has a first input/output port, a first output port and a first input port. The first optical coupling apparatus is configured to route downstream optical channel signals input at the first input/output port to the first output port, and is configured to route upstream optical channel signals input at the first input port to the first input/output port. The second optical coupling apparatus has a second input/output port, a second input port and a second output port. The second optical coupling apparatus is configured to route downstream optical channel signals input at the second input port to the second input/output port, and configured to route upstream optical channel signals input at the second input/output port to the second output port. The optical switching apparatus for dropping optical channel signals comprises an input configured to receive optical channel signals, a plurality of drop ports, a plurality of working optical waveguides, a plurality of bypass optical waveguides, a plurality of optical bypass switches, a plurality of wavelength selective optical switching elements and an output. The optical bypass switches each have at least one input, a first output and a second output. The input is configured to receive downstream optical channel signals from the first optical coupling apparatus first output port. The first output is connected to a respective working optical waveguide and the second output connected to a respective bypass optical waveguide. The optical bypass switches are reconfigurable between a working configuration in which received optical channel signals are routed to the respective first output and a bypass configuration in which received optical channel signals are routed to the respective second output. The wavelength selective optical switching elements are coupled to respective working optical waveguides. The wavelength selective optical switching elements are operable to drop optical channel signals at different channel wavelengths from respective working optical waveguides to respective drop ports. The output is configured to output downstream optical channel signals that have not been dropped to a drop port to the second optical coupling apparatus second input port. The optical combiner has a plurality of input ports and an output port. The optical combiner is configured to combine upstream optical channel signals received at input ports and output the combined upstream optical channel signals from the output port. A first input port is configured to receive upstream optical channel signals from the second coupling apparatus second output port. Other input ports of said plurality of input ports are configured as add ports to receive upstream optical channel signals to be added. The output port is configured to output combined upstream optical channel signals to the first optical coupling apparatus first input port.

The optical add-drop multiplexer, OADM, is advantageously reconfigurable and enables bi-directional operation, thus it can be used in network deployment such as fronthaul and backhaul. The ROADM can interwork with packet switch/routers. The drop ports are fully reconfigurable without creating any disturbance to the other optical channel signals, thus enabling dynamic reconfiguration of the wavelength associated with each Add/Drop port pair, and thus the use of fully tunable transceivers. The OADM removes the problem of controlling the resonance wavelength of WSS at add ports, enabling simpler manufacture and operation. The OADM enables use of integrated silicon photonics for the optical switching apparatus and the available in market TRX and a simple passive component for the add ports, leveraging on the tunability of TRX in transmission. The OADM provides full tunability both at transmission and receiver side, with full compatibility with commercial tunable transceivers that are tunable only in transmission. The complexity of the drop side is reduced by the separation of upstream and downstream optical channel signals and the provision of bypass filters to enable wavelength selective optical switching elements to be bypassed while they are undergoing a wavelength reconfiguration. Furthermore, by operating on downstream optical channel signals only, the spacing between the channels doubles, resulting in relaxed requirements on the wavelength profile of the wavelength selective optical switching elements, and it is no longer necessary to avoid crosstalk at the wavelength selective optical switching elements with upstream channels.

The OADM supports bi-directional operation without requiring any polarization diversity scheme in the ‘add’ part of the circuit. The ‘add’ side of the OADM does not need a complex control system to set up the add wavelength, as is required when using a chain of resonant filters to add wavelengths, the add function is accomplished with passive components. The splitter/combiner also do not add impairments to the added channels as losses are the same for all the add ports, in contrast with add port solutions using resonant filters in sequence. This use of amplifiers to be avoided or, if necessary, the use of a single booster amplifier for the whole add side.

In an embodiment, the optical add-drop multiplexer has a plurality, N, of add ports and the optical combiner is an optical splitter having a splitting ratio that is the closest power of 2 that is greater than N+1.

In an embodiment, the optical add-drop multiplexer further comprises an optical amplifier between the optical combiner output and the first optical coupling apparatus first input port. This provides a simplified amplification scheme on the transmitter side of the ROADM. It is possible to independently amplify uplink and downlink optical channel signals with standard fibre amplifiers if required.

Corresponding embodiments and advantages apply also to the communications network node described below.

An aspect provides a communications network node comprising an optical add-drop multiplexer, a plurality of optical receivers and a plurality of optical transmitters. The optical add-drop multiplexer comprises first optical coupling apparatus, second optical coupling apparatus, optical switching apparatus for dropping optical channel signals and an optical combiner. The first optical coupling apparatus has a first input/output port, a first output port and a first input port. The first optical coupling apparatus is configured to route downstream optical channel signals input at the first input/output port to the first output port, and is configured to route upstream optical channel signals input at the first input port to the first input/output port. The second optical coupling apparatus has a second input/output port, a second input port and a second output port. The second optical coupling apparatus is configured to route downstream optical channel signals input at the second input port to the second input/output port, and configured to route upstream optical channel signals input at the second input/output port to the second output port. The optical switching apparatus for dropping optical channel signals comprises an input configured to receive optical channel signals, a plurality of drop ports, a plurality of working optical waveguides, a plurality of bypass optical waveguides, a plurality of optical bypass switches, a plurality of wavelength selective optical switching elements and an output. The optical bypass switches each have at least one input, a first output and a second output. The input is configured to receive downstream optical channel signals from the first optical coupling apparatus first output port. The first output is connected to a respective working optical waveguide and the second output connected to a respective bypass optical waveguide. The optical bypass switches are reconfigurable between a working configuration in which received optical channel signals are routed to the respective first output and a bypass configuration in which received optical channel signals are routed to the respective second output. The wavelength selective optical switching elements are coupled to respective working optical waveguides. The wavelength selective optical switching elements are operable to drop optical channel signals at different channel wavelengths from respective working optical waveguides to respective drop ports. The output is configured to output downstream optical channel signals that have not been dropped to a drop port to the second optical coupling apparatus second input port. The optical combiner has a plurality of input ports and an output port. The optical combiner is configured to combine upstream optical channel signals received at input ports and output the combined upstream optical channel signals from the output port. A first input port is configured to receive upstream optical channel signals from the second coupling apparatus second output port. Other input ports of said plurality of input ports are configured as add ports to receive upstream optical channel signals to be added. The output port is configured to output combined upstream optical channel signals to the first optical coupling apparatus first input port. The optical receivers are coupled to respective drop ports and the optical transmitters are coupled to respective add ports.

Embodiments of the invention will now be described, by way of example only, with reference to the accompanying drawings.

### BRIEF DESCRIPTION OF THE DRAWINGS

FIGS. 1 to 4 are block diagrams illustrating embodiments of optical switching apparatus for dropping optical channel signals;

FIGS. 5 and 8 are block diagrams illustrating embodiments of optical add drop multiplexers;

FIGS. 6 and 7 are plots illustrating the free spectral range (FSR) and operating range (OR) of wavelength selective switching elements of the optical switching apparatus of FIG. 5; and FIGS. 9 and 10 are block diagrams illustrating embodiments of a communications network node.

### DETAILED DESCRIPTION

The same reference numbers will be used for corresponding features in different embodiments.

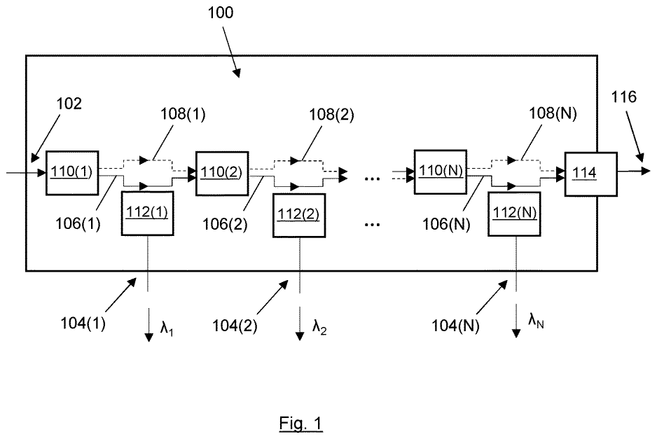

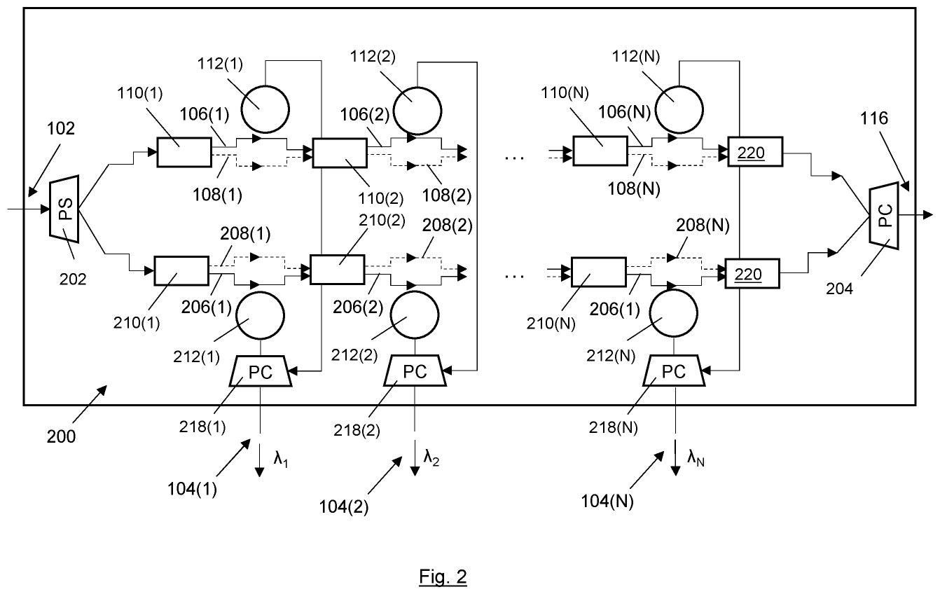

Referring to FIG. 1, an embodiment provides optical switching apparatus 100 for dropping optical channel signals. The apparatus comprises an input 102 configured to receive optical channel signals, a plurality of drop ports 104, a plurality of working optical waveguides 106, plurality of bypass optical waveguides 108, a plurality of optical bypass switches 110, a plurality of wavelength selective optical switching elements 112, and an output 116.

The optical bypass switches, 110(1) to 110(N), each have at least one input, a first output and a second output. The input is configured to receive optical channel signals. The first output is connected to a respective working optical waveguide, 106(1) to 106(N), and the second output is connected to a respective bypass optical waveguide, 108(1) to 108(N). The optical bypass switches are reconfigurable between a working configuration and a bypass configuration. In the working configuration, received optical channel signals are routed to the first output of the optical bypass switch. In the bypass configuration, received optical channel signals are routed to the second output of the optical bypass switch.

Each wavelength selective optical switching element, 112(1) to 112(N), is coupled to its respective working optical waveguide, 106(1) to 106(N). Each wavelength selective optical switching element is operable to drop optical channel signals at a different channel wavelength, λ₁ to λ_{N}, from its respective working optical waveguide to its respective drop port, 104(1) to 104(N).

The output 116 is configured to output optical channel signals that have not been dropped to a drop port (these channels are often referred to as ‘transit’ optical channel signals). A further bypass optical switch 114 is provided at the output to couple the final working optical waveguide 104(N) or bypass optical waveguide 108(N) to the output.

In an embodiment, the optical bypass switches 110 are operative to be configured in the bypass configuration in response to a respective bypass control signal. The wavelength selective optical switching elements 112 are tunable wavelength selective optical switching elements. The wavelength selective optical switching elements are operative to change the channel wavelength at which optical channel signals are dropped in response to a respective wavelength control signal received when the respective optical bypass switch is configured in the bypass configuration by a respective bypass control signal.

For example, the wavelength selective optical switching elements, 112(1) to 112(N), are configured to drop optical channel signals at channel wavelengths λ₁ to λ_{N} of a larger set of channel wavelengths λ₁ to λ_{M}. Wavelength selective optical switching element 112(1) is configured to drop optical channel signals at wavelength λ₁. To change the wavelength at which wavelength selective optical switching element 112(1) is operable to drop optical channel signals, a bypass control signal is provided to the optical bypass switch 110(1) associated with wavelength selective optical switching element 112(1), so that all optical channel signals passing through the apparatus 100 are routed onto the bypass optical waveguide 108(1). A wavelength control signal is then provided to the wavelength selective optical switching element 112(1), the wavelength control signal is configured to change the wavelength at which wavelength selective optical switching element 112(1) is operable to drop optical channel signals to λ_{N+1}. Once the wavelength has been changed, the bypass control signal is removed from the optical bypass switch 110(1) and the optical channel signals are again routed into the working optical waveguide.

In an embodiment, the bypass optical switches are Mach-Zehnder interferometers, MZI. The first MZI 110(1) has one input and subsequent MZIs 110(2) to 110(N) each have two inputs. The first working optical waveguide 106(1) is connected to a first input of the second MZI 110(2) and the first bypass optical waveguide 108(1) is connected to the second input of the second MZI 110(2), and so on. Depending on the status of the preceding wavelength selective optical switching element, the subsequent MZIs will either receive optical channel signals at the first input, from the preceding working optical waveguide, or at the second input, from the preceding bypass optical waveguide.

Alternatively, the bypass optical switches may be microelectromechanical mirrors, MEMS.

In an embodiment, the wavelength selective optical switching elements 112 are optical resonator based filters.

In an embodiment, the wavelength selective optical switching elements 112 are micro-ring resonator, MRR, channel dropping filters.

An MRR channel dropping filter may comprise a single MRR as described for example in Wim Bogaerts et al, “Silicon microring resonators”, Laser Photonics Review, vol. 6, no. 1, pages 47-73, 2012. Alternatively, an MRR channel dropping filter may comprise may comprise a plurality of MRRs configured as a cascade of MRRs or coupled MRRs, as described for example in B. E. Little et al, “Microring Resonator Channel Dropping Filters”, Journal of Lightwave Technology, vol. 15, no. 6, June 1997, pages 998-1005.

Referring to FIG. 2, an embodiment provides optical switching apparatus 200 for dropping optical channel signals. The apparatus 200 includes a polarization diversity scheme. The apparatus comprises an input 102 configured to receive optical channel signals, a polarization splitter 202, a plurality of drop ports 104 and respective drop polarization combiners 218, an output polarization combiner 204, and an output 116.

The polarization splitter 202 is provided at the input and is configured to split received optical channel signals into respective first polarization components and second polarization components.

The output polarization combiner 204 is provided at the output and is configured to recombine first polarization components and second polarization components of optical channel signals that have not been dropped to a drop port. The drop polarization combiners 218 provided at respective drop ports are configured to recombine first polarization components and second polarization components of optical channel signals for delivery to the respective drop ports.

Each drop port, 104(1) to 104(N), has a respective first optical bypass switch, 110(1) to 110(N), first working optical waveguide, 106(1) to 106(N), first bypass optical waveguide, 108(1) to 108(N), and first wavelength selective optical switching element, 112(1) to 112(N) for the optical channel signal first polarization components. Each drop port, 104(1) to 104(N), also has a respective second optical bypass switch, 210(1) to 210(N), second working optical waveguide 206(1) to 206(N), second bypass optical waveguide 208(1) to 208(N), and second wavelength selective optical switching element 212(1) to 212(N) for the optical channel signal second polarization components.

The first and second wavelength selective optical switching elements 112, 212 are micro-ring resonator, MRR, channel dropping filters, as described above.

At each drop port, the respective first and second wavelength selective optical switching elements are operable to drop first polarization components and second polarization components at the same channel wavelength, λ₁ to λ_{N}, from the first working optical waveguide and the second working optical waveguide respectively to the drop polarization combiner at the drop port.

At each drop port, the optical channel signals can either be routed onto the respective working optical waveguide, coupled to the wavelength selective switching element of that port, or be routed onto the respective bypass optical waveguide:
if the wavelength selective switching element of the drop port is configured to drop optical channel signals at its respective wavelength then the optical channel signal at that wavelength will be dropped
if the wavelength selective switching element of the drop port is not configured to drop optical channel signals at its respective wavelength then the optical channel signal at that wavelength will continue along the working optical waveguide and will not be dropped
if the wavelength selective switching element of the drop port is undergoing a wavelength reconfiguration process, then the optical channel signals are deviated onto the bypass optical waveguide so that the wavelength selective switching element being reconfigured does not cause any disturbance on the optical channel signals.

This allows the full reconfiguration of the optical switching apparatus 200 since the bypass removes the restrictions coming from the crosstalk and the interference that is generated during the tuning procedure of a wavelength selective switching element, such as a MRR. This restriction has historically been a substantial limitation on the reconfigurability of a drop port, which would otherwise require a complex scheduling of the optical channel signals to be dropped. For this reason, the existing solutions such as the ROADM in references cited above, keep the wavelengths that can be dropped fixed after an initial configuration. In the optical switching apparatus 200 there are no restrictions on the optical channel signals that can be dropped at the different drop ports.

In an embodiment, the optical bypass switches 110, 210 are operative to be configured in the bypass configuration in response to a respective bypass control signal. The wavelength selective optical switching elements 112, 212 are tunable wavelength selective optical switching elements. The wavelength selective optical switching elements are operative to change the channel wavelength at which optical channel signals are dropped in response to a respective wavelength control signal received when the respective optical bypass switch is configured in the bypass configuration by a respective bypass control signal.

For example, the wavelength selective optical switching elements 112(1), 212(1) at drop port 104(1) are configured to drop first polarization components and second polarization components at wavelength λ₁. To change the wavelength at which optical channel signals are dropped to the drop port 104(1), bypass control signals are provided to both optical bypass switches 110(1), 210(1) associated with wavelength selective optical switching elements 112(1), 212(1) so that all first polarization components and second polarization components passing through the apparatus 200 are routed onto the first bypass optical waveguide 108(1) or the second bypass optical waveguide 208(1) respectively. Wavelength control signals are then provided to the wavelength selective optical switching elements 112(1), 212(1), the wavelength control signals are configured to change the wavelength at which wavelength selective optical switching elements 112(1), 212(1) are operable to drop first polarization components and second polarization components to λ_{N+1}. Once the wavelength has been changed, the bypass control signals are removed from the optical bypass switches 110(1), 210(1) and the first polarization components and second polarization components are again routed into the working optical waveguides 106(1), 206(1).

In an embodiment, the bypass optical switches are Mach-Zehnder interferometers, MZI. Alternatively, the bypass optical switches may be microelectromechanical mirrors, MEMS.

In an embodiment, the polarization splitter 202 is a polarization splitter converter configured to split received optical channel signals into first TE polarization components and TM polarization components, and to convert the TM polarization components into second TE polarization components. The output polarization combiner 204 is an output polarization combiner converter configured to receive first TE polarization components and second TE polarization components. The output polarization combiner is configured to recombine first TE polarization components and second TE polarization components of respective optical channel signals that have not been dropped to a drop port. The drop polarization combiners 218 are drop polarization combiner converters configured to receive first TE polarization components and second TE polarization components. The drop polarization combiner converters are configured to recombine first TE polarization components and second TE polarization components of optical channel signals to be dropped for delivery to respective drop ports 104.

In an embodiment, the polarization splitter converter comprises a dual-polarization grating coupler or a polarization splitter rotator.

In an embodiment, the output polarization combiner converter and the drop polarization combiner converters comprise dual-polarization grating couplers or polarization splitter rotators.

In an embodiment, optical amplifiers are provided between wavelength selective optical switching elements 112(1), 212(1) and drop polarization combiner converters 218.

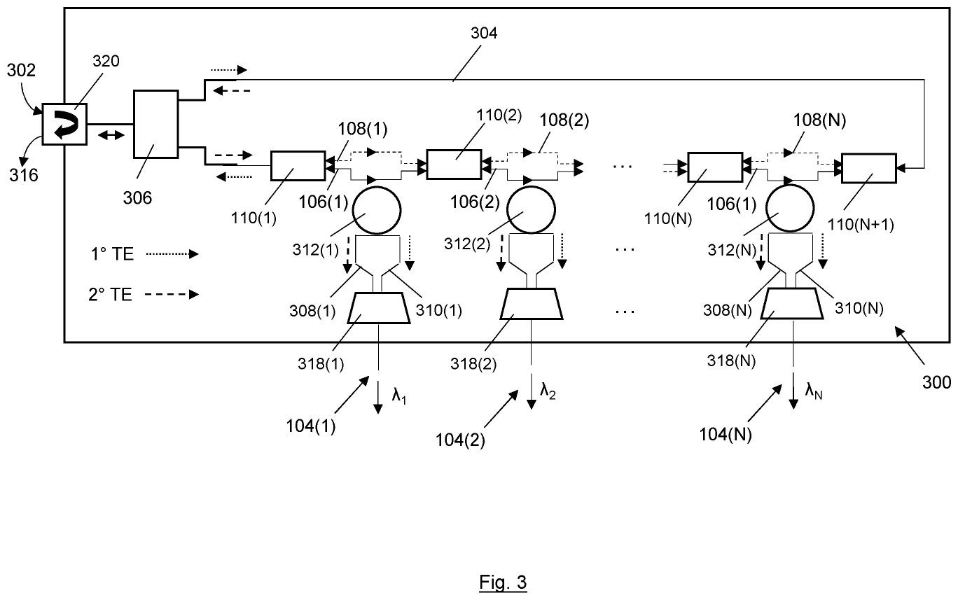

Referring to FIG. 3, an embodiment provides optical switching apparatus 300 for dropping optical channel signals.

The apparatus 300 comprises an input 302 configured to receive optical channel signals, a bus optical waveguide 304, a polarization splitter converter 306, a plurality of bypass optical switches 110, a plurality of working optical paths 106, a plurality of bypass optical paths, a plurality of plurality of wavelength selective optical switching elements 312, optical drop paths 308, 310, a plurality of drop ports 104, a plurality of polarization combiner converters 318, and an output 316.

The input 302 and the output 316 comprise the input and the output of an optical circulator 320. The input/output port of the circulator is connected to an input/output of the polarization splitter converter 306.

The bus optical waveguide 304 has a first end and a second end. The working optical paths, 106(1) to 106(N), and the bypass optical switches 110 comprise part of the bus optical waveguide. When a bypass optical switch 110 is in the bypass configuration, the respective bypass optical path 108 then forms part of the bus optical waveguide.

The polarization splitter converter 306 is configured to split received optical channel signals into first TE polarization components and TM polarization components, and to convert the TM polarization components into second TE polarization components. The polarization splitter converter 306 is configured to couple first TE polarization components into the bus optical waveguide to travel in one direction and to couple second TE polarization components into the bus optical waveguide to travel in an opposite direction.

The wavelength selective optical switching elements 312 are micro-ring resonator, MRR, channel dropping filters, as described above.

Each wavelength selective optical switching element 312 has a respective first optical drop path 308 and a respective second optical drop path 310. Each wavelength selective optical switching element 312(1) to 312(N) is operable to drop first TE polarization components and second TE polarization components at a different channel wavelength, λ₁ to λ_{N}, from its respective working optical waveguide to its first optical drop path 308 and second 310 optical drop path, respectively.

Each polarization combiner converter, 318(1) to 318 (N), is provided between its respective drop port, 104(1) to 104(N), and its first optical drop path 308 and second 310 optical drop path. The polarization combiner converters are configured to receive first TE polarization components and second TE polarization components from the respective first and second optical drop paths. The polarization combiner converters are configured to combine received first TE polarization components and second TE polarization components of respective optical channel wavelengths to form optical channel signals for delivery to the respective drop port, 104(1) to 104(N).

This embodiment therefore addresses polarization diversity, avoiding duplication of wavelength selective optical switching elements.

In an embodiment, the polarization splitter converter 306 comprises a dual-polarization grating coupler or a polarization splitter rotator.

In an embodiment, the polarization combiner converters 318 comprise dual-polarization grating couplers or polarization splitter rotators.

In an embodiment, the wavelength selective optical switching elements 312 are micro-ring resonator, MRR, channel dropping filters, as described above.

In an embodiment, the bus optical waveguide 304 is a folded optical waveguide.

In an embodiment, the optical channel signals carry information bits having a bit time. The respective optical path difference of the bus optical waveguide 304 to each wavelength selective optical switching element 312 from the first end of the bus optical waveguide and from the second end of the bus optical waveguide results in a delay between the respective first TE polarization component and second TE polarization component of a fraction of the bit time.

In an embodiment, the delay is up to 10% of the bit time.

In an embodiment, the optical switching apparatus 300 further comprises delay elements in drop paths 308, 310. The delay elements are configured to add different compensating delays to one of the first TE polarization component and second TE polarization component of channels being dropped.

In an embodiment, optical amplifiers are provided in the optical drop paths 308, 310.

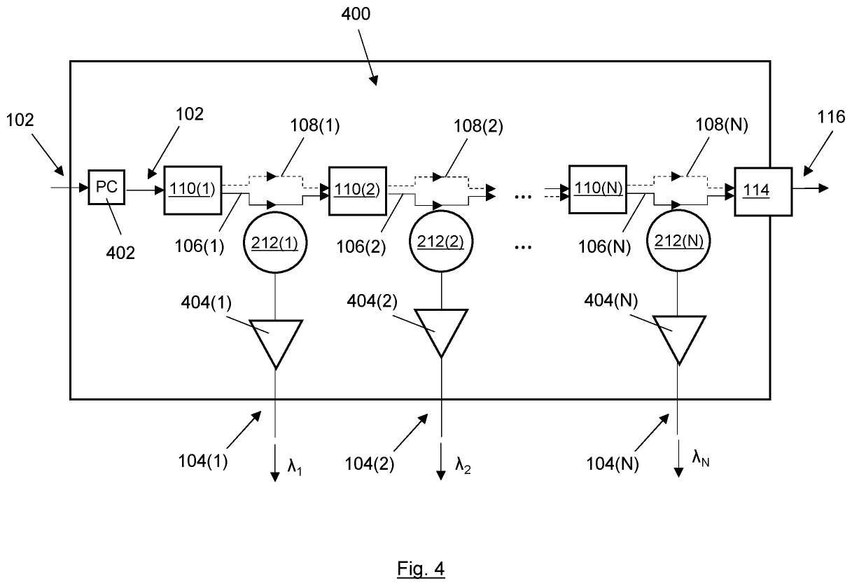

Referring to FIG. 4, an embodiment provides optical switching apparatus 400 for dropping optical channel signals. This apparatus 400 addresses polarization variability using a polarization controller, thus avoiding the need for a polarization diversity scheme.

The wavelength selective optical switching elements 212 are micro-ring resonator, MRR, channel dropping filters, as described above.

The optical switching apparatus 400 further comprises a polarization controller 402 at the input.

In an embodiment, optical amplifiers 404 are provided between MRR channel dropping filters 212 and respective drop ports 104.

Corresponding embodiments and advantages apply also to the optical add-drop multiplexer and the communications network node described below.

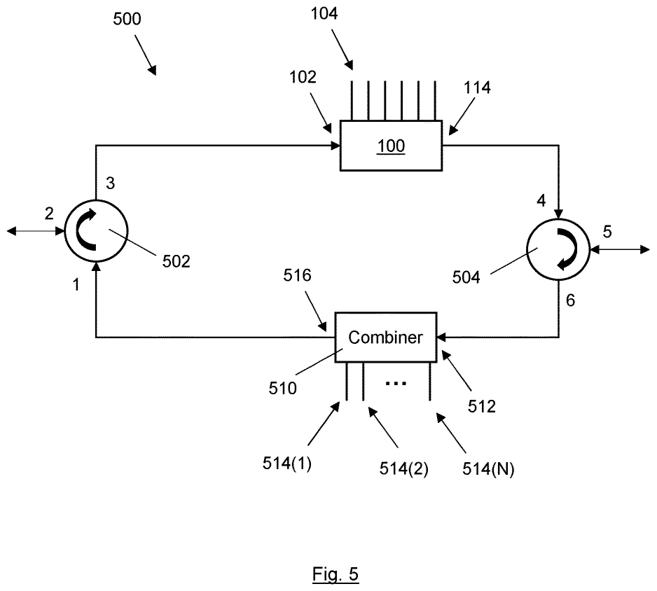

Referring to FIG. 5, an embodiment provides an optical add-drop multiplexer 500 comprising first optical coupling apparatus 502, second optical coupling apparatus 504, optical switching apparatus 100 for dropping optical channel signals, as described above, and an optical combiner 510. Optical switching apparatus 200, 300, 400 as described above may alternatively replace the optical switching apparatus 100.

The first optical coupling apparatus 502 has a first input/output port 2, first output port 3 and a first input port 1. The first optical coupling apparatus is configured to route downstream optical channel signals input at the first input/output port 2 to the first output port 3, and is configured to route upstream optical channel signals input at the first input port 1 to the first input/output port 2.

The second optical coupling apparatus 504 has a second input/output port 5, a second input port 4 and a second output port 6. The second optical coupling apparatus is configured to route downstream optical channel signals input at the second input port 4 to the second input/output port 5, and is configured to route upstream optical channel signals input at the second input/output port 5 to the second output port 6.

The input 102 of the optical switching apparatus 100 is configured to receive downstream optical channel signals from the first optical coupling apparatus first output port 3. The output 114 of the optical switching apparatus is configured to output downstream optical channel signals that have not been dropped to a drop port to the second optical coupling apparatus second input port 4.

The optical combiner 510 has a plurality of input ports 512, 514 and an output port 516. A first input port 512 is configured to receive upstream optical channel signals from the second coupling apparatus second output port 6. The other input ports, 514(1) to 514(N), are configured as add ports to receive upstream optical channel signals to be added. The optical combiner 510 is configured to combine upstream optical channel signals received at input ports 512, 514 and output the combined upstream optical channel signals from the output port 516. The output port 516 is configured to output combined upstream optical channel signals to the first optical coupling apparatus first input port 1.

The number of optical channel signals that can be added/dropped is N for both uplink and downlink directions. The downlink optical channel signals are received by the first optical coupling apparatus 502. At the optical switching apparatus 100, up to N optical channel signals can be dropped to respective drop ports 104(1) to 104(N). As discussed above, the wavelength of the optical channel signals that are dropped can be reconfigured and the optical switching apparatus 100 can be configured to drop only selected ones of the N optical channel signals. All the optical channel signals that are not dropped to a drop port are output at the output port 114 and proceed in the downlink direction, via the second optical coupling apparatus 504.

The optical combiner 510 adds up to N optical channel signals to uplink optical channel signals received from the second optical coupling apparatus 504. The splitting ratio of the optical combiner must be the closest power of 2 that is greater than N+1; e.g., 8 for N=6. The optical combiner is a passive optical splitter and does not require any electronic control or power as would be required in existing ROADM solutions. The optical combiner also does not add impairments in the added optical channel signals as losses are the same for all the input ports, in contrast with solutions using resonant add filters in sequence. This allows to avoid the use of amplifiers or, if necessary, the use of a single booster optical amplifier 552 for the whole uplink branch, as shown in the optical add drop multiplexer 550 embodiment of FIG. 5.

In an embodiment, the optical channel signals, at channel wavelengths λ₁ to λ_{N}, have a channel spacing of 100 GHz. The wavelength selective optical switching elements 112 have a rejection bandwidth at −20 dB lower than the channel spacing. The first optical coupling apparatus 502 and the second optical coupling apparatus 504 are optical circulators.

The first optical coupling apparatus 502 removes the uplink optical channel signals from the optical switching apparatus 100, meaning that in an interleaved optical channel wavelength plan the requirement is that the bandwidth at −20 dB is less than 200 GHz. The 1 dB bandwidth instead depends on the data rate, e.g. around 37 GHz for a data rate of around 25 Gbauds.

The free spectral range of the wavelength selective optical switching elements 112, that is the distance between two consecutive resonances, should be larger than the operation range of the filter, that is FSR=channel spacing multiplied by the number of optical channel signals in the wavelength grid. In a typical application, the number of optical channels in the wavelength grid may be 2×18 (downlink and uplink) and with a channel spacing of 100 GHz, so the FSR of a wavelength selective optical switching elements operating in C band would be around 29 nm.

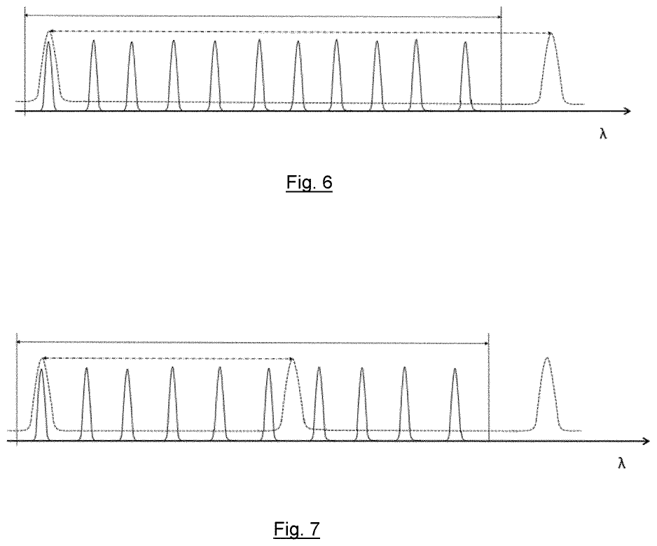

However, the fact that the wavelength selective optical switching elements 112 only need to filter half of the optical channel signals, with double the wavelength grid channel spacing between two downlink channels, allows some strategy for selecting only one optical channel signal even if there are two resonances within the operation range. FIGS. 6 and 7 illustrate such a strategy in which, instead of designing a wavelength selective optical switching element with very large FSR, it is possible to fit the second resonance in the empty space between two optical channel signals, by choosing a specific FSR. This is possible if the space between two optical channel signals is sufficient as in the case where the adjacent channel is not present due to the separation between uplink and downlink in an interleaved wavelength grid. Such strategy may enable an extension of the operating range of the wavelength selective optical switching elements and accommodate even more than 2×18 optical channel signals.

The optical add-drop multiplexer 500 enables reduced complexity as compared to existing ROADM, enabling reduced cost of inventory, simplification of operation in field both during configuration and fault recovery, dynamic network planning, on the fly reconfigurability, bidirectional transmission, and full reconfiguration of the add/drop ports.

Tunable optical filters relieve operators from deploying and storing many variants of wavelength fixed optical add drop multiplexers, OADM, where each fixed OADM corresponds to a specific group of wavelengths, by replacing the fixed OADMs with a single reconfigurable device. This leads to advantages in network planning simplification and saving of costs for the acquisition and maintenance of backup components, which are necessary to cope with possible failures, as failures can be addressed with a single tunable device.

The optical add-drop multiplexer 500 makes use of consolidated photonic elements such as fibre circulators and combiners to accomplish those functions (circulating and splitting) where there is no substantial advantage in the use of a non-commercial integrated photonic element. The optical add-drop multiplexer 500 supports bi-directional operation without introducing any polarization diversity scheme in the ‘add’ part of the circuit, and enables independent amplification of uplink and downlink optical channel signals with standard fibre amplifiers, if required. The optical add-drop multiplexer 500 enables the requirements on the wavelength selective switching elements to be relaxed since the circulator separates the downlink and uplink channels: the spacing of downlink optical channel signals is twice the spacing of the channels in the channel wavelength grid. This means that the wavelength selective switching elements do not have to account for interference from 2 high power aggressor channels at 100 GHz, instead the nearest aggressor are low power channels at 200 GHz distance (the transmit power is much larger than the received power). The ‘add’ section of the OADM 500 does not need a complex control system to set up the add wavelength as would be required when using a chain of resonant filters at add ports; the add function is accomplished with passive components since wavelength tuning can be performed at an associated transceiver.

The OADM 500 enables the application of integrated photonics only in those functions where there is clear advantage in its application, in a manner that helps a progressive transition from actual components to higher performance components. This approach allows to test integrated solutions in the system by providing intermediate steps between consolidated solutions that are not integrated and fully integrated protonic solutions. In an embodiment, the optical add-drop multiplexer 500, 550 has a plurality, N, of add ports 514. The optical combiner is an optical splitter having a splitting ratio that is the closest power of 2 that is greater than N+1.

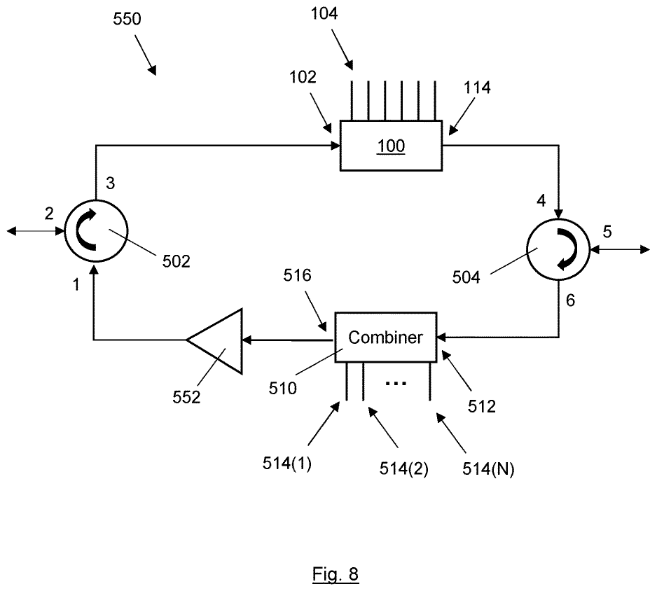

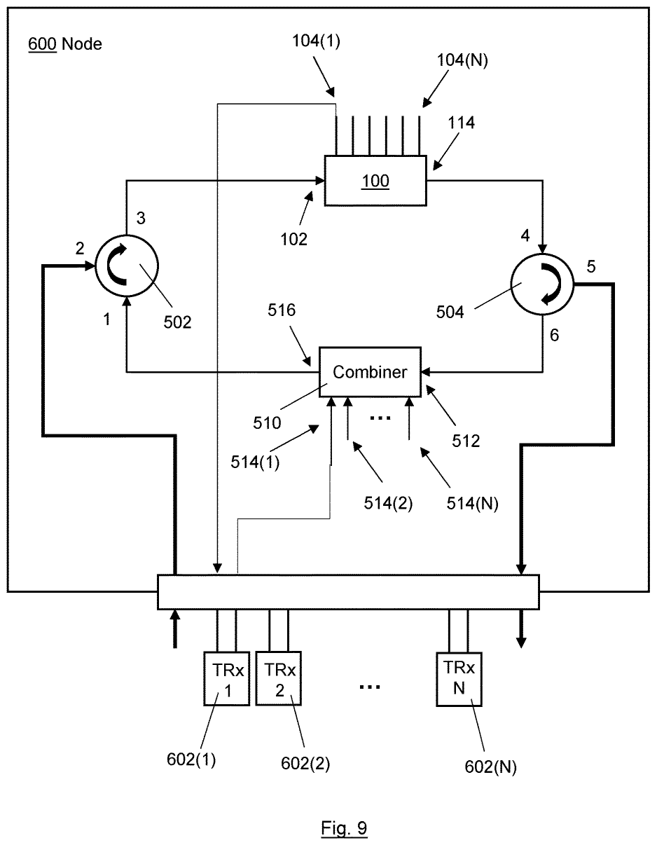

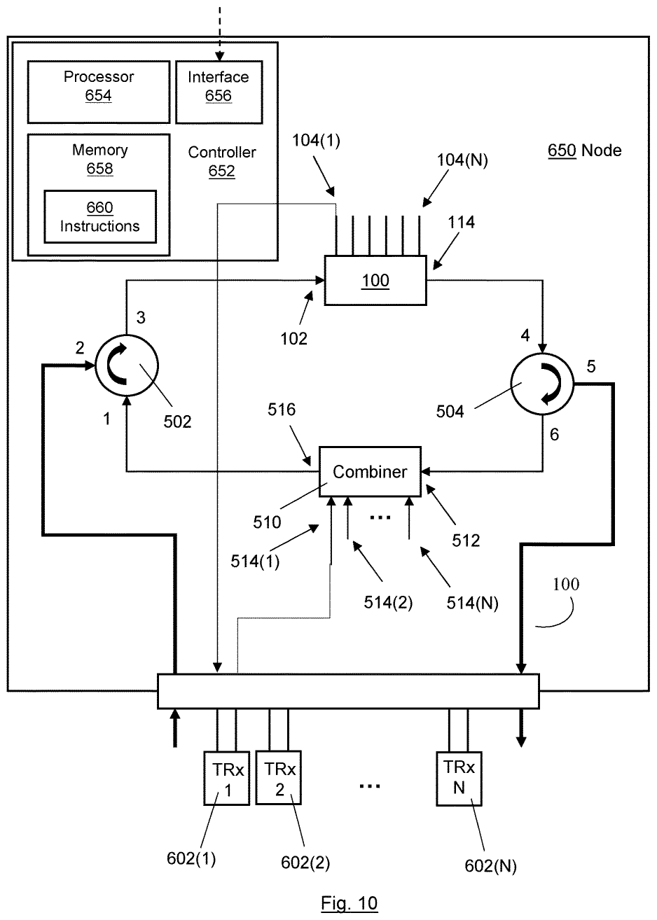

In an embodiment, illustrated in FIG. 8, the optical add drop multiplexer 550 further comprises an optical amplifier 552 between the optical combiner output 516 and the first optical coupling apparatus first input port 1.

An embodiment provides a communications network node 600 as shown in FIG. 9. The node comprises an optical add-drop multiplexer 500, 550 as described above, a plurality of optical receivers and a plurality of optical transmitters. For example, the optical receivers and optical transmitters may be provided as a plurality of optical transceivers 602(1) to 602(N) The receivers of the optical transceivers 602 are coupled to respective drop ports 104(1) to 104(N). The transmitters of the optical transceivers 602 are coupled to respective add ports 514(1) to 514(N).

The node provides a ROADM that combines integrated and discrete components, reducing the manufacturing complexity of the ROADM as compared to a ROADM fully realized in silicon photonics. The integration in silicon photonics may be utilized to realize tunable MRR for drop ports and to make them fully reconfigurable via a bypass optical waveguide that allows the tuning of an MRR without interfering with other channels. A standard fibre splitter, which is a low cost and passive component, may be used to provide the add ports. Such passive add ports leverage on the tunability of existing tunable TRX that are tunable in transmission.

Referring to FIG. 10, an embodiment provides a communications network node 650 further comprising a controller 652. The controller comprises a processor 654, interface 656 and memory 658 containing instructions 660 executable by the processor whereby the controller is operative to generate a bypass control signal and a wavelength control signal, for the optical switching apparatus 100.

The controller 652 is operative to receive a configuration control signal from a central node, for example an optical line terminal or a central office, the control signal including information on the wavelength (channel) to be assigned to a drop port.

The controller 652 is operative to, following receipt of a configuration control signal including an indication of a drop port to be tuned and a new wavelength for the respective wavelength selective switching element, to:
a. Check if the optical bypass switch of a selected drop port wavelength is in the bypass configuration (if the port is unused, the optical bypass switch may be in bypass already);
b. If the optical bypass switch is not in the bypass configuration, generate a bypass control signal to cause the optical bypass switch to go into the bypass configuration;
c. Generate a wavelength control signal to tune the wavelength selective switching element to the new wavelength; and
d. Stop generating the bypass control signal.

1. An optical switching apparatus for dropping optical channel signals, the optical switching apparatus comprising:
an input configured to receive optical channel signals;
a plurality of drop ports;
a plurality of working optical waveguides;
a plurality of bypass optical waveguides;
a plurality of optical bypass switches each having at least one input configured to receive optical channel signals, a first output connected to a respective working optical waveguide and a second output connected to a respective bypass optical waveguide, wherein the optical bypass switches are reconfigurable between a working configuration in which received optical channel signals are routed to the respective first output and a bypass configuration in which received optical channel signals are routed to the respective second output;
a plurality of wavelength selective optical switching elements coupled to respective working optical waveguides, operable to drop optical channel signals at different channel wavelengths from respective working optical waveguides to respective drop ports; and
an output configured to output optical channel signals that have not been dropped to a drop port.

2. The optical switching apparatus of claim 1, wherein:
the optical bypass switches are operative to be configured in the bypass configuration in response to a respective bypass control signal; and
the wavelength selective optical switching elements are tunable wavelength selective optical switching elements and are operative to change the channel wavelength at which optical channel signals are dropped in response to a respective wavelength control signal received when the respective optical bypass switch is configured in the bypass configuration by a respective bypass control signal.

3. The optical switching apparatus of claim 1, wherein the bypass optical switches are Mach-Zehnder interferometers or microelectromechanical mirrors.

4. The optical switching apparatus of claim 1, wherein the wavelength selective optical switching elements are optical resonator based filters.

5. The optical switching apparatus of claim 4, wherein the optical resonator based filters are micro-ring resonator channel dropping filters.

6. The optical switching apparatus of claim 1, further comprising:
a polarization splitter at the input configured to split received optical channel signals into respective first polarization components and second polarization components;
an output polarization combiner provided at the output configured to recombine first polarization components and second polarization components of optical channel signals that have not been dropped to a drop port; and
respective drop polarization combiners provided at drop ports configured to recombine first polarization components and second polarization components of optical channel signals for delivery to respective drop ports, wherein:
drop ports have respective first optical bypass switches, first working optical waveguides, first bypass optical waveguides, and first wavelength selective optical switching elements for the optical channel signal first polarization components and respective second optical bypass switches, second working optical waveguides, second bypass optical waveguides, and second wavelength selective optical switching elements for the optical channel signal second polarization components; and
the first and second wavelength selective optical switching elements of respective drop ports are operable to drop first polarization components and second polarization components at a same channel wavelength from the respective first working optical waveguide and second working optical waveguide to the drop polarization combiner at the drop port.

7. The optical switching apparatus of claim 6, wherein:
the polarization splitter is a polarization splitter converter configured to split received optical channel signals into first Transverse Electric (TE) polarization components and Transverse Magnetic (TM) polarization components, and to convert the TM polarization components into second TE polarization components;
the output polarization combiner is an output polarization combiner converter configured to receive first TE polarization components and second TE polarization components, and configured to recombine first TE polarization components and second TE polarization components of respective optical channel signals that have not been dropped to a drop port; and
the drop polarization combiners are drop polarization combiner converters configured to receive first TE polarization components and second TE polarization components, and configured to recombine first TE polarization components and second TE polarization components of optical channel signals for delivery to respective drop ports.

8. The optical switching apparatus of claim 1, further comprising:
a bus optical waveguide having a first end and a second end, wherein the working optical paths and the bypass optical switches comprise part of the bus optical waveguide;
a polarization splitter converter configured to split received optical channel signals into first Transverse Electric (TE) polarization components and Transverse Magnetic (TM) polarization components, and to convert the TM polarization components into second TE polarization components, and to couple first TE polarization components into the bus optical waveguide to travel in one direction and to couple second TE polarization components into the bus optical waveguide to travel in an opposite direction;
a plurality of first and second optical drop paths, wherein the wavelength selective optical switching elements are operable to drop optical channel signals at different channel wavelengths from respective working optical waveguides to respective first and second optical drop paths; and
a plurality of polarization combiner converters provided between respective drop ports and first and second optical drop paths coupled to respective wavelength selective optical switching elements, the polarization combiner converters configured to receive first TE polarization components and second TE polarization components from respective first and second optical drop paths, and configured to combine first TE polarization components and second TE polarization components of respective optical channel wavelengths to form optical channel signals for delivery to the respective drop port.

9. The optical switching apparatus of claim 7, wherein the polarization splitter converter comprises a dual-polarization grating coupler or a polarization splitter rotator.

10. The optical switching apparatus of claim 7, wherein the polarization combiner converters comprise dual-polarization grating couplers or polarization splitter rotators.

11. The optical switching apparatus of claim 8, wherein the bus optical waveguide is a folded optical waveguide.

12. The optical switching apparatus of claim 8, wherein the optical channel signals carry information bits having a bit time and wherein the respective optical path difference of the bus optical waveguide to each wavelength selective optical switching element from the first end of the bus optical waveguide and from the second end of the bus optical waveguide results in a delay between the respective first TE polarization component and second TE polarization component of a fraction of the bit time.

13. The optical switching apparatus of claim 12, wherein the delay is not greater than 10% of the bit time.

14. The optical switching apparatus of claim 8, further comprising delay elements in drop paths of drop ports, the delay elements configured to add different compensating delays to one of the first TE polarization component and second TE polarization component of channels being dropped.

15. The optical switching apparatus of claim 1, further comprising a polarization controller at the input.

16. The optical switching apparatus of claim 1, further comprising respective optical amplifiers between wavelength selective optical switching elements and respective drop ports.

17. An optical add-drop multiplexer, comprising:
a first optical coupling apparatus having a first input/output port, first output port and a first input port, and configured to route downstream optical channel signals input at the first input/output port to the first output port, and configured to route upstream optical channel signals input at the first input port to the first input/output port;
a second optical coupling apparatus having a second input/output port, a second input port and a second output port, and configured to route downstream optical channel signals input at the second input port to the second input/output port, and configured to route upstream optical channel signals input at the second input/output port to the second output port;
the optical switching apparatus of claim 1, wherein the input is configured to receive downstream optical channel signals from the first optical coupling apparatus first output port and the output is configured to output downstream optical channel signals that have not been dropped to a drop port to the second optical coupling apparatus second input port; and
an optical combiner having a plurality of input ports and an output port, and configured to combine upstream optical channel signals received at input ports and output the combined upstream optical channel signals from the output port, wherein a first input port is configured to receive upstream optical channel signals from the second coupling apparatus second output port, other input ports of said plurality of input ports are configured as add ports to receive upstream optical channel signals to be added and the output port is configured to output combined upstream optical channel signals to the first optical coupling apparatus first input port.

18. The optical add-drop multiplexer of claim 17, wherein the optical add-drop multiplexer has N add ports, the optical combiner is an optical splitter having a splitting ratio that is the closest power of that is greater than N+1, and N is greater than 1.

19. The optical add-drop multiplexer of any one of claim 17, further comprising an optical amplifier between the optical combiner output and the first optical coupling apparatus first input port.

20. A communications network node comprising:
the optical add-drop multiplexer of claim 17;
a plurality of optical receivers coupled to respective drop ports; and
a plurality of optical transmitters coupled to respective add ports.
